(19) United States
(12) Patent Application Publication
(10) Pub. No.: US 2017/0275945 A1
(43) Pub. Date: Sep. 28, 2017

(54) RETRACTABLE PRIVACY SYSTEM AND METHOD

(71) Applicants: David R. Hall, Provo, UT (US); Andrew Priddis, Provo, UT (US); Charles Wood, Provo, UT (US); Grant Getts, Provo, UT (US)

(72) Inventors: David R. Hall, Provo, UT (US); Andrew Priddis, Provo, UT (US); Charles Wood, Provo, UT (US); Grant Getts, Provo, UT (US)

(21) Appl. No.: 15/078,307

(22) Filed: Mar. 23, 2016

(51) Int. Cl. E06B 9/72; E06B 9/08; E06B 9/44; E06B 9/40

(52) U.S. Cl. CPC E06B 9/72; E06B 9/40; E06B 9/08; E06B 9/44; E06B 2009/6809

(57) ABSTRACT

A retractable privacy system for roll-up walls and doors is disclosed. In one embodiment, such a retractable privacy system includes one or more drums rotated by one or more motors to draw in or let out one or more flexible sheets from the drum. Multiple motors and drums may work in synchronization to achieve a desired result. In certain embodiments, various inputs are used to automatically open or close roll-up walls and doors. In other embodiments, the retractable privacy system interfaces with a thermostat or security system to achieve a desired result.

### BACKGROUND

Field of the Invention

This invention relates to retractable walls, windows, doors, insulation, sound barriers, and other retractable or reconfigurable privacy systems and methods.

Background of the Invention

Roller shades, roller blinds, and roller awnings have been developed to meet the needs of blocking light and keeping out bugs and mosquitoes. But these technologies lack specific environmental and insulating properties. To address the specific needs of humidity, temperature, lighting, air pressure, security, access, and insulation control of an area, a retractable privacy technology has been developed.

### SUMMARY

The disclosed invention has been developed in response to the present state of the art and, in particular, in response to the problems and needs in the art that have not yet been fully solved by currently available retractable privacy systems. Accordingly, retractable privacy system and methods in accordance with the invention have been developed to provide improved privacy and control of homes, buildings, and outdoor areas. The features and advantages of the invention will become more fully apparent from the following description and appended claims, or may be learned by practice of the invention as set forth hereinafter.

Consistent with the foregoing, a retractable privacy system for providing dynamic humidity, temperature, lighting, air pressure, security, access, and insulation control of an area is disclosed. A corresponding method is also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings.

FIG. 1 is a perspective view of a single sheet of a privacy system.

FIG. 2 is a perspective view of three sheets of a privacy system.

FIG. 3 is a perspective view a 90-degree configuration of a privacy system.

FIG. 4 is a side view of a double sheet configuration of a privacy system.

FIGS. 5A and 5B show a front view of a garage in accordance with an embodiment of the current invention.

FIGS. 6A and 6B show a front view of a doorway in accordance with an embodiment of the current invention.

FIGS. 7A and 7B show a front view of a garage in accordance with an embodiment of the current invention.

FIGS. 8A and 8B show a front view of a doorway in accordance with an embodiment of the current invention.

FIG. 9 is a cross-sectional view of an embodiment of a drum in accordance with an embodiment of the current invention.

FIGS. 10 is a diagram of privacy system inputs and outputs in accordance with an embodiment of the current invention.

### DETAILED DESCRIPTION

It will be readily understood that the components of the present invention, as generally described and illustrated in the Figures herein, may be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

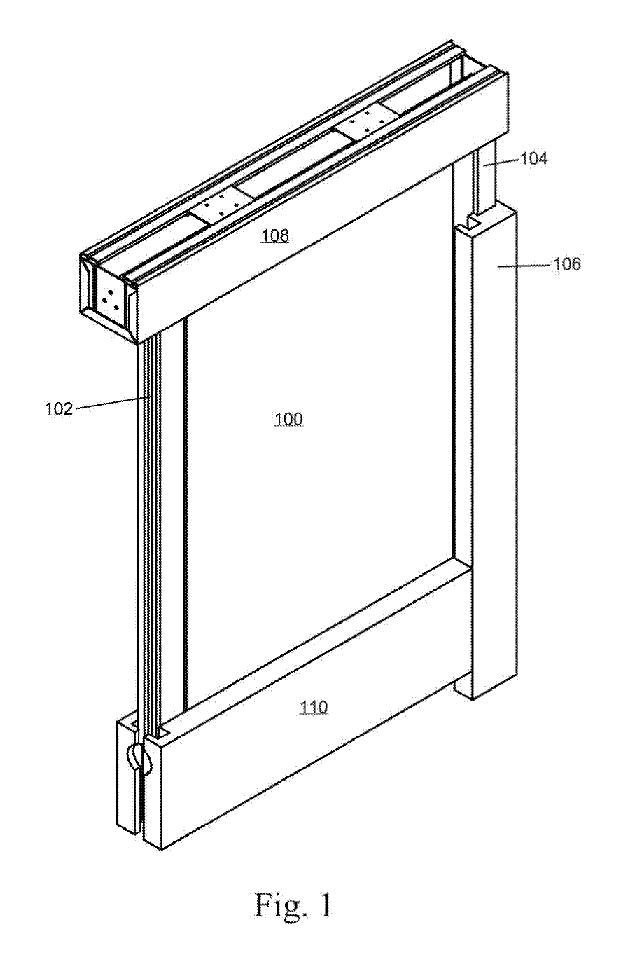

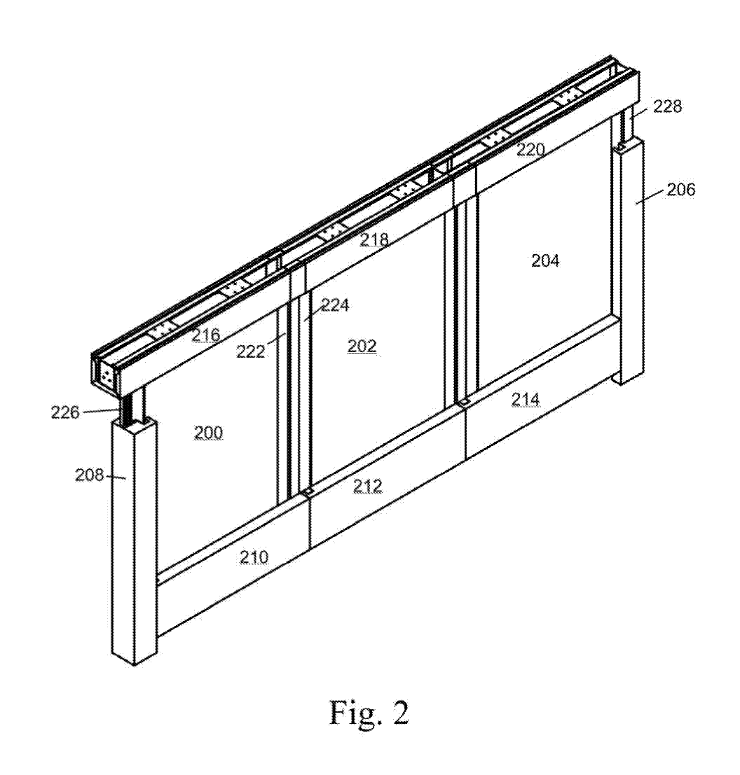

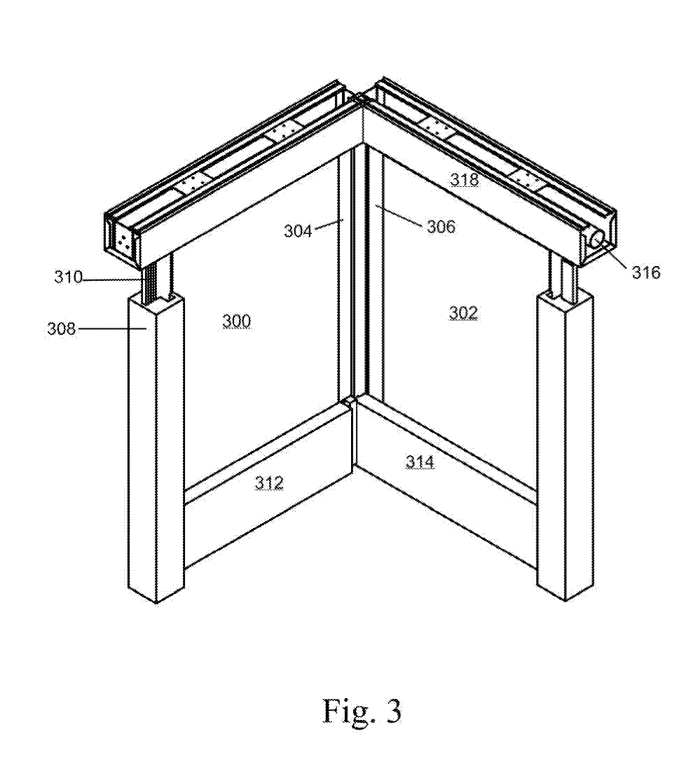

Referring to FIG. 1, a privacy system is shown having a flexible sheet 100. Flexible sheet 100 may be at least partially made of plastic, nylon, polyvinylidene fluoride, polyethylene, metal, lead, a metal alloy, polyvinylchloride, or vinyl. In a preferred embodiment flexible sheet 100 has a density of greater than 0.05 lb/in³ and a thickness of less than 0.2 of an inch. The high density of the sheet material 100 is necessary in order to achieve insulation against noise and heat transfer. Insulation against electromagnetic radiation may also be achieved by having a sheet 100 with one or more layers of an iron containing element. A flexible sheet may also be impregnated with various types and forms of material to obtain a desired shielding. Shielding against nuclear particles may also be achieved by adding a layer of lead or other heavy metal between layers or laminated within sheet 100. Flexible sheet 100 may be a continuous flexible sheet having a length of between 6 to 10 feet and a width of 7-10 feet and a thickness of less than 0.2 of an inch. A flexible interface or flexible mating surface 102 and 104 is attached to or molded into flexible sheet 100. Sheet 100 and flexible interface surfaces 102 and 104 roll up into headrail 108. Flexible interface or flexible mating surface 102 and 104 are configured to interlock with each other so that additional sheets may be added as shown in FIGS. 2-3. Opposite side edges of the flexible interfaces 102 and 104 have the ability to interlock with one another. Drawbar 110 connects to a bottom edge of sheet 100. Drawbar 110 moves up and down with sheet 100 and may be hid inside of head rail 108 when sheet 100 is in a fully retracted position. Fixed side rail 106 may be used to secure one edge of sheet material 100 to a wall or other secure structural element by way of flexible interface 102 or 104.

Referring now to FIG. 2, a multiple sheet privacy system is shown in a straight line. Each of the sheets 200, 202, and 204 may be 8 feet wide and 8 feet high and ⅛-inch-thick spanning a distance of 24 feet from side rail 208 to side rail 206. Each sheet may raise or lower individually or synchronously. Drawbars 210, 212, and 214 each interconnect with each other when in a fully retracted position as shown in FIG. 2. Flexible material 222, 224, 226 and 228 are all similar mating surfaces which interconnect with one another. A particular mention is made to the fact that sidewall 208 interfaces with the same flexible design 226 which also is used when mating flexible surfaces 224 and 222. This allows greater flexibility in design and placement of sheets 200, 202, and 204 when making a privacy area.

In FIG. 3, sheets 300 and 302 are connected together at an angle at flexible interfaces 304 and 306. Drawbars 312 and 314 interconnect at an angle. It should be noted that no ridged sidewall interface is needed where flexible interfaces 304 and 306 connect. This allows greater flexibility in privacy area design. Drum 316 is shown in headrail 318. Headrail 318 is not drawn to scale and may be larger depending on the length and thickness of sheets 302 and 300.

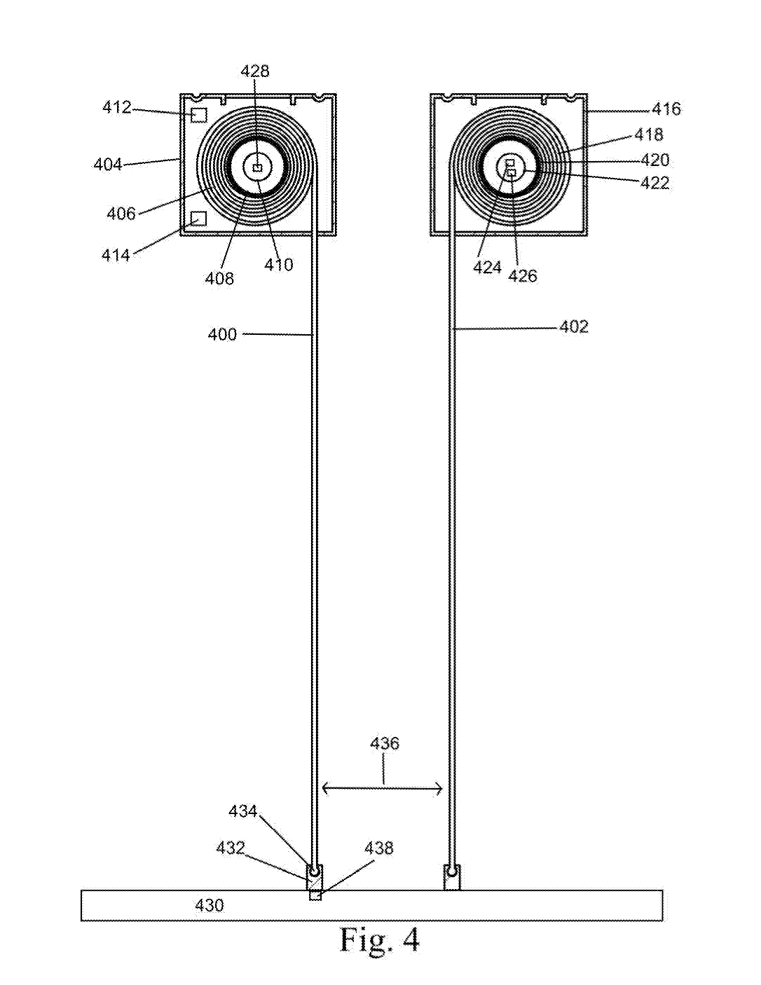

Now referring to FIG. 4, a side view of two flexible sheets are shown used in combination for greater insulation and privacy. This type of system could be used in place of a wall in a home. Space 436 is space between flexible sheets 400 and 402. This space may be chosen to represent a common wall thickness such as 3-4 inches. Headrail 404 houses a drum 408. Flexible sheet 400 is rolled up around drum 408 as shown at 406. Drum 408 may contain a motor 410. Motor 410 may be used to retract or extend flexible sheet 400. Motor 410 may contain an encoder 428 for tracking and determining a position of flexible sheet material in reference to ground surface 430. A braking mechanism may also be attached to motor 410 for providing a way of holding flexible sheet material in a fixed position. A controller 412 may also be included in headrail 404 as shown in FIG. 4 or may be attached to the motor as shown at 424. Additionally, the controller 412 may be located inside of drum 408 or drum 420. A battery 414 may be located in headrail 404 or in drum 408 or attached to motor 410. Controller 412 may contain a processor and a motor controller and a wireless communication system. One or more controllers 412 and 424 may be used to form a network. The network may be a wireless network. Motors 410 and 420 may be operated in a synchronous manner or may be operated individually. Additionally, more than one motor 410 may be located in a single drum 408. Each of the motors may be operated by a separate controller or by a separate motor controller within a single controller. Drawbar 432 may be made out of an extruded metal and have additional weight added to it to hold flexible sheet material 400 in a taut position. Drawbar 432 may also be connected to ground surface 430 by a magnetic force 438 or other mechanical means.

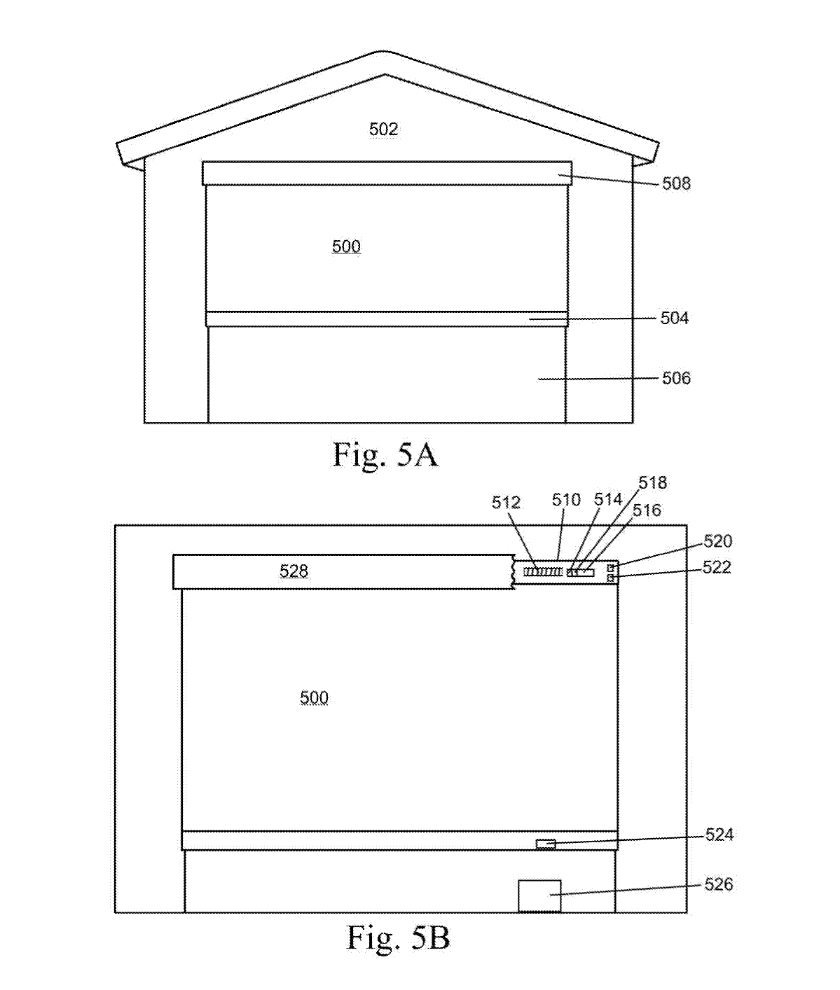

Now referring to FIG. 5A, a garage 502 is shown with flexible sheet material 500 used as the garage door. Opening 506 connect an area which is outside of garage 502 with an area inside of garage 502. In this instance, flexible sheet material 500 is used instead of the garage door. In FIG. 5B, we see a view of inside of headrail 528. Headrail 528 may include one or more springs 512 for assisting the motor 516 in opening and closing flexible sheet material 500. Motor 516 may include a locking or braking mechanism 518 for locking sheet material in a fixed position. Motor 516 may also be connected to an encoder 514 for determining position and tracking a position of flexible sheet material 500. Motor 516 may also be used as a generator while lowering sheet material 500 and charge battery 522. A sensor 524 may be used to detect an obstruction 526 and may provide feedback to controller 520. The flexible sheet material may be stopped from lowering upon detection of an obstruction in its path.

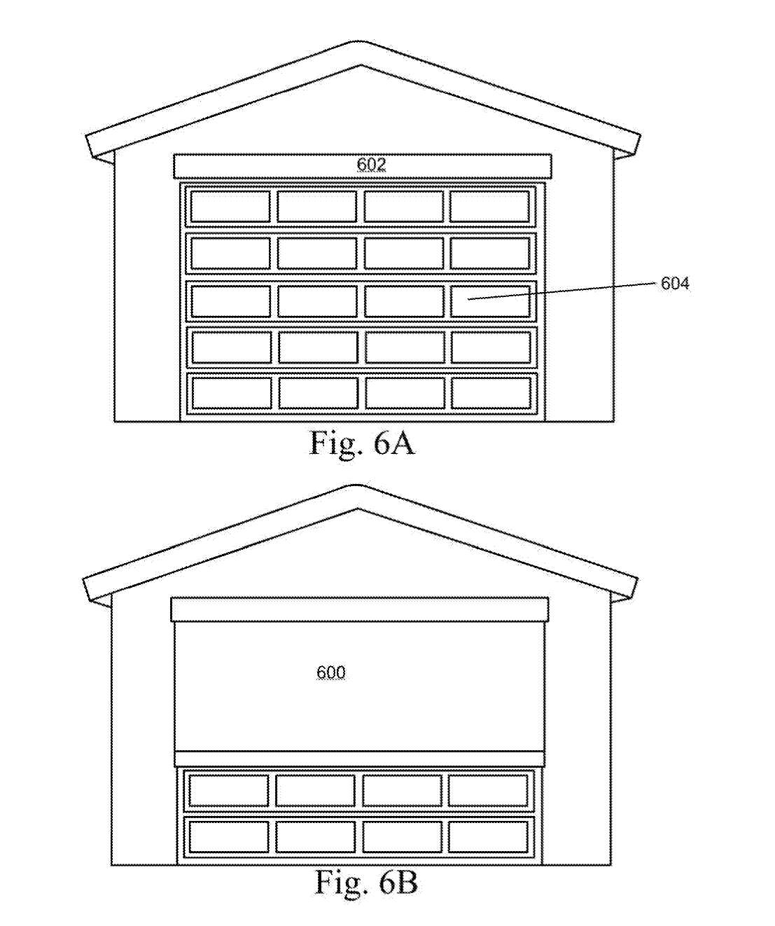

In FIGS. 6A and 6B, flexible sheet material 600 is used in combination with an existing garage door 604. Flexible sheet material 600 may be used on an inside of a garage or on the outside of a garage to cover a garage door and provide additional heat and sound insulation value.

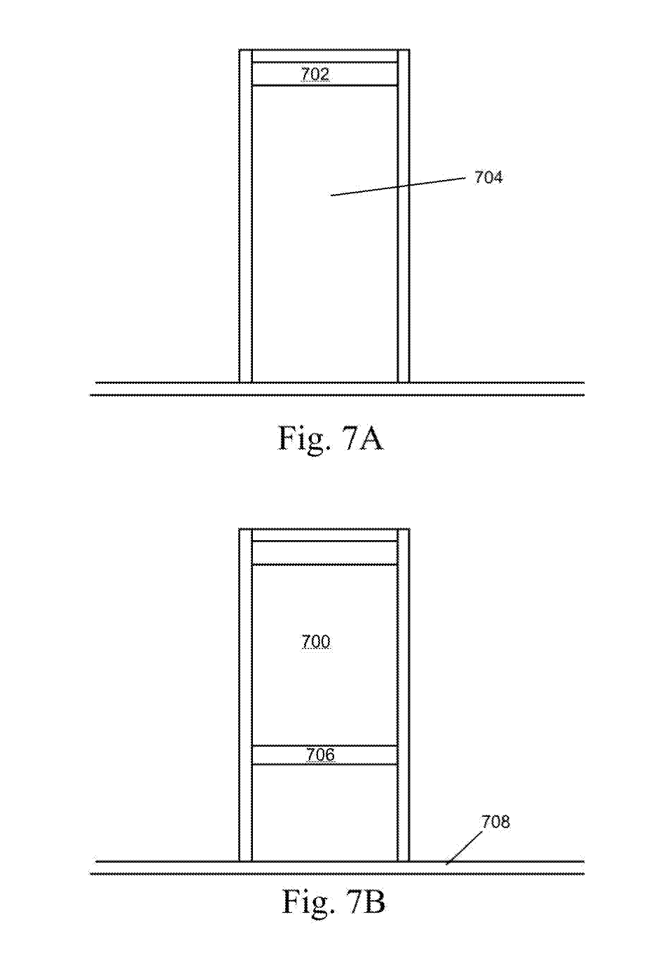

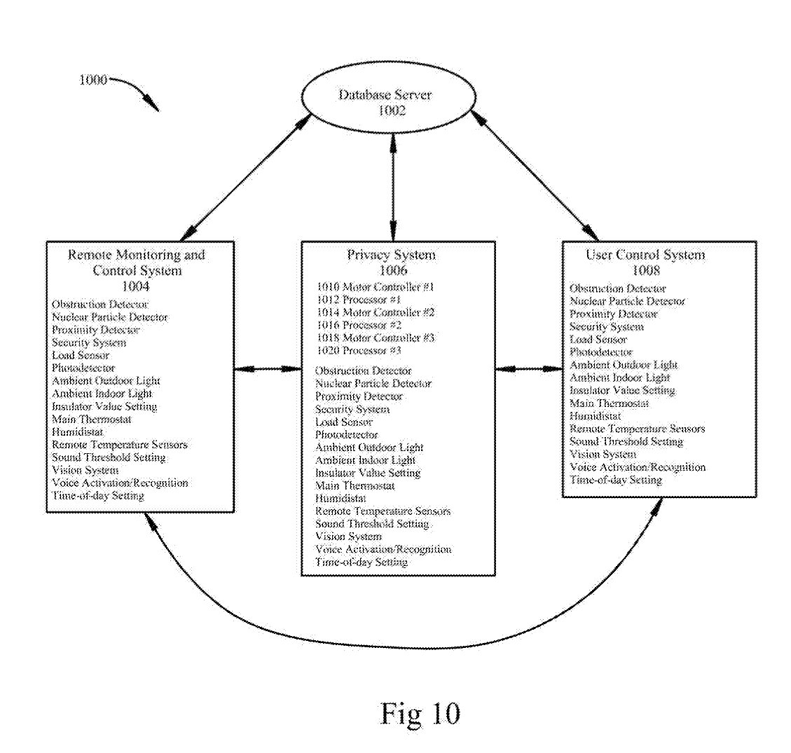

FIGS. 7A and 7B show a flexible sheet material 700 used as a door in an entrance way 704. A controller may be configured to open and close the sheet material in response to various inputs and outputs as described in relation to FIG. 10.

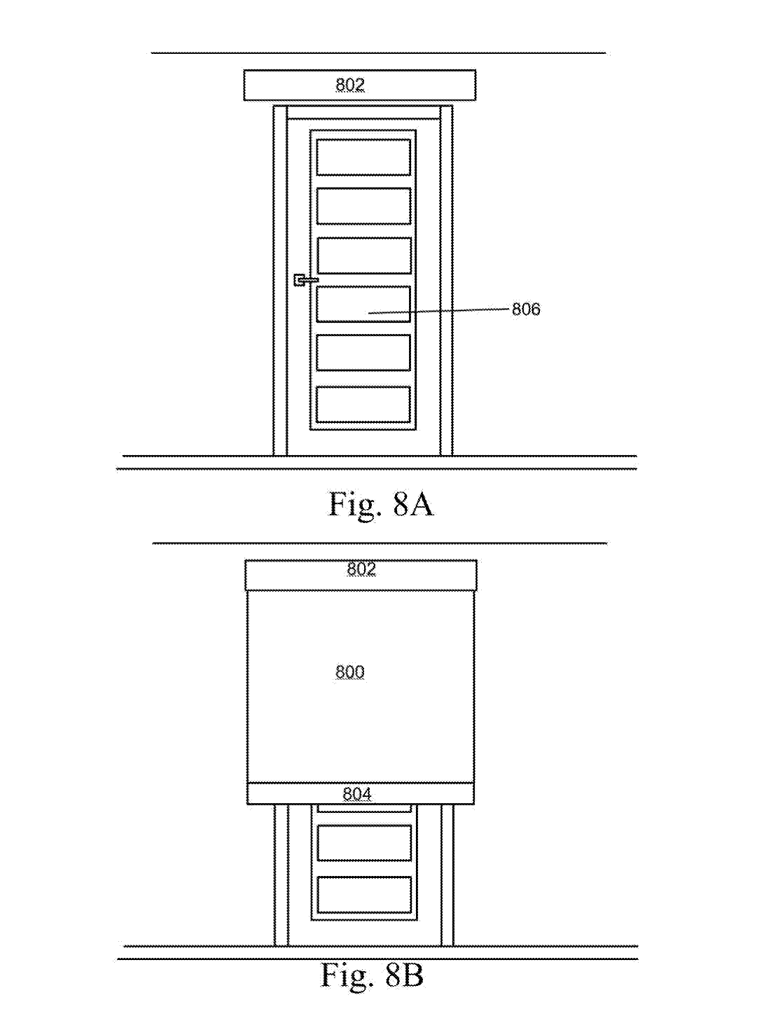

In FIGS. 8A and 8B, flexible sheet material 600 is used in combination with an existing garage door 604. Flexible sheet material 800 may be used on an inside of an entryway door 806 or on the outside of an entryway door provide additional heat and sound insulation value. Doors are not good sound insulator and flexible sheet material provides extra heat and sound insulation value to an existing door.

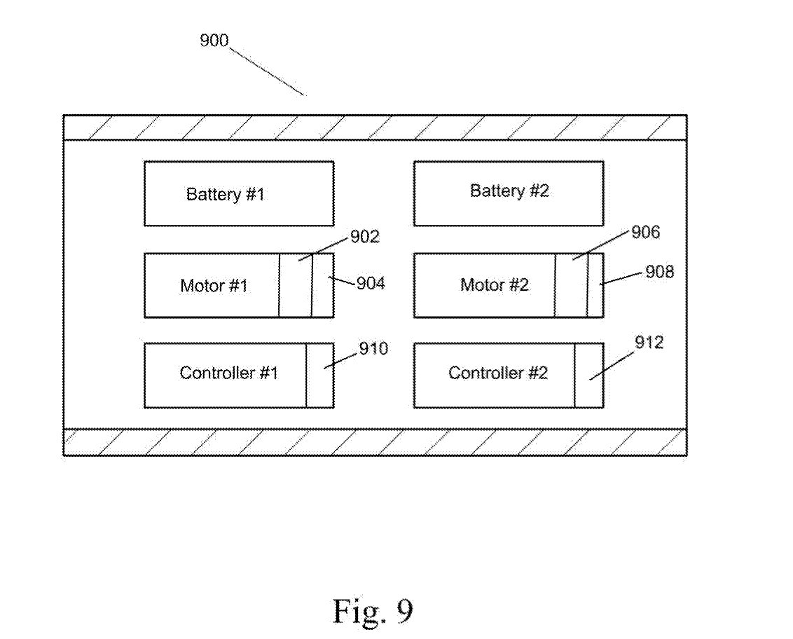

FIG. 9 shows an inside view of a drum 900. The single drum contains two motors, two batteries, and two controllers. Alternatively, the two motor may use a single controller and a single battery. A controller may contain a wireless control section 910 or 912 for networking the controller together and also for communicating with a remote wireless system. Wireless control section 910 and 912 may use Wifi, Bluetooth, Zigbee, Sure-fi and/or cellular communication technology to communicate with sensors and with remote systems. Wireless control section 910 and 912 may be used to synchronously lift a single flexible sheet or multiple flexible sheets.

FIG. 10 shows various inputs and outputs in connection with one or more controllers as shown in FIGS. 4, 5 and 9. Privacy system 1006 may be connected to locally or remotely to database server 1002, remote monitoring and control system 1004, user control system 1008, or to any combination thereof. Privacy system 1006 may contain one or more motors within one or more drums. A single drum may contain multiple motors working synchronously in order to achieve proper lifting of a heavy or dense sheet material. For example, a 10′×10′ sheet of mass loaded vinyl with a density of 0.060 lb/in³ weighing over 100 lbs. may need to be lifted by multiple motors. In another example, multiple motors may be operated to lift or lower multiple flexible sheets to create a privacy area or to make an opening large enough for a specific use. Privacy system 1006, Remote monitoring system 1004, and User Control system 1008 may be networked together and each have similar sensor inputs or the ability to read sensor data. Sensor data may include a time-of-day setting, detection of an obstruction in a path of a flexible sheet material, detection of a proximity of a specific person, detection of a nuclear particle, detection of a security issue, an indoor photodetector, an outdoor photodetector, an input from a thermostat, an input from a humidistat, a remote temperature sensor, a sound or noise level, a vision sensing system, a user recognition system, etc.

In an example, a proximity detector may detect a movement at a doorway and automatically rollup a sheet material. A specific person may be recognized by RFID or by a vision recognition system and the doorway may be opened based on access privileges of the specific person. Voice activation and recognition may also be used to distinguish a specific person and open a doorway on command or just to open a doorway based on a specific command with indifference to the person.

In another example, one or more photodetectors may be used to determine a brightness value of light inside and outside. A user setting may be compared to the brightness values and a decision to open or close a flexible sheet material may be made automatically. This could be used in homes, offices, and greenhouses. Similarly, temperature values can be determined on each side of a flexible sheet and a determination may be made to open, close or partially open or partially close a flexible sheet material based on a user threshold setting such as a predetermined temperature setting or humidity setting or lighting setting or a combination of threshold settings.

In another example, a privacy system may provide an input signal to a security system. If motion is detected or if the flexible sheet material is cut or torn or moved out of place manually, a security signal could be sent to a security system or to a cellular phone. A security system might then make a decision to report an intrusion or take other action. A security system might retract and extend one or more flexible sheets in order to scare or deter a robber, the robber thinking that someone is present. A text message might be sent to a phone or a recorded voice message might be delivered.

In another example, a nuclear particle detector detects radioactive particles and drops down all flexible sheets which contain lead or another heavy metal to keep radioactive particle from getting into a specific area.

In another example, a thermostat sends a signal to open a flexible sheet material based on at least two temperatures. A home or building may be temperature balanced by opening and closing flexible sheet materials. This may also be accomplished automatically, by local sensors connected to a controller of a flexible sheet doorway. Pressure may also be controlled within one or more areas by opening or closing a flexible sheet doorway.

In another example, a flexible sheet controller receives a wireless signal reporting an outside temperature drop below a threshold value of an inside temperature value and a flexible sheet controller lowers one or more flexible sheet materials in response to an outside temperature falling.

In another example, a flexible sheet controller receives a wireless signal reporting an outside temperature rise above a preset threshold value of a current inside temperature and, in response, a flexible sheet controller raises one or more flexible sheet materials in response to an outside temperature rising.

Humidity may also be controlled by raising and lowering flexible sheet materials. Dynamic sound damping may also be accomplished by raising and lowering flexible sheet material.

In another example, a privacy system with a single flexible sheet is commanded to roll-up. Multiple motors work together within a single drum to roll-up the flexible sheet.

User control system 1008 may include a computer, a laptop, a cellular phone, a wireless remote control device, a battery-less wireless remote control device, a passive RFID card or FOB, or a cloud-based user interface console.

Privacy system 1006 may include one or more controllers for controlling one or more motors and communicating with remote monitoring and control system 1004 and/or user control system 1008 by way of database server 1002 or directly.

Remote monitoring and control system 1004 may be maintained remotely by a third party such as a security company, a maintenance company, and/or a management company.

The retractable privacy system and method disclosed herein may be embodied in other specific forms without departing from their spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A retractable privacy system comprising:
two or more drums, each of the drums containing one or more motors inside of the drum;
a flexible sheet rotated around each of the two or more drums by each of the one or more motors to roll-up or roll-down at least one or more flexible sheets, the at least one or more flexible sheets each having side edges which are parallel to each other and perpendicular to a top and a bottom edge of the one or more flexible sheets;
a flexible mating surface attached to each side edge of each of the one or more flexible sheets, wherein the flexible mating surface of a first flexible sheet of the one or more flexible sheets is configured to connect with the flexible mating surface of a second flexible sheet of the one or more flexible sheets, wherein the first flexible sheet and the second flexible sheet are adjacent;
a battery located inside of each of the drums; and
a separate controller for controlling each of the two or more drums and each of the one or more motors inside of each of the two or more drums, wherein when one or more of each of the controllers receive a signal to roll-up or roll-down at least one of the adjacent flexible sheets, the flexible mating surface of the first flexible sheet connects or disconnects from the flexible mating surface of the second flexible sheet.

2. The retractable privacy system of claim 1, wherein each of the separate controllers of each of the two or more drums are networked together.

3. The retractable privacy system of claim 2, wherein the raising or lowering of two or more sheets are synchronized.

4. The retractable privacy system of claim 1, wherein each sheet material is at least partially made of at least one of a plastic, nylon, polyvinylidene fluoride, polyethylene, metal, lead, a metal alloy, polyvinylchloride, or vinyl.

5. The retractable privacy system of claim 2, wherein each of the separate controllers are wirelessly controlled.

6. The retractable privacy system of claim 1, wherein at least one of the flexible sheets are raised or lowered at least partially based on at least one of: a light level, a sound level, a temperature, a detection of nuclear particles, a time-of-day setting, a user input, a security system input, an insulation value setting, a sound threshold setting, a proximity detection, a wireless control signal, a voice activation signal, a voice recognition signal, a humidity signal, a vision system signal, a detected obstruction, or a sensed load.

7. The retractable privacy system of claim 1, wherein one or more of the flexible sheets are used as at least one of: a wall, a window, a door, a roof or a garage door.

8. The retractable privacy system of claim 1, wherein the time-of-day setting is dynamically determined based on a length of light of the light level within a 24-hour period.

9. The retractable privacy system of claim 1, wherein the one or more sheets are used to partition an open area into smaller areas.

10. The retractable privacy system of claim 9, wherein the one or more sheets magnetically connect to a floor or ground plane of the open area.

11. A method comprising:
rotating two or more drums, each of the drums containing one or more motors to roll up or roll out flexible sheets, the one or more motors being inside of each of the two or more drums and at least two or more flexible sheets each having side edges which are parallel to each other and perpendicular to a top and a bottom edge of the two or more flexible sheets;
controlling the one or more motors with a motor controller and a battery which are located in each of the two or more drums; and
mating two or more of the flexible sheets with a flexible mating surface attached to each side edge of each of the two or more flexible sheets when motor control commands to the one or more motor controllers are received to roll up or roll out at least one of the two or more flexible sheets.

12. The method of claim 11, wherein each of the controllers of each of the two or more drums are networked together.

13. The method of claim 12, wherein the raising or lowering of two or more sheets are synchronized.

14. The method of claim 11, wherein the one or more sheet material is at least partially made of at least one of a plastic, nylon, polyvinylidene fluoride, polyethylene, metal, lead, a metal alloy, polyvinylchloride, or vinyl.

15. The method of claim 11, wherein the controller is wirelessly controlled.

16. The method of claim 11, wherein at least one of the flexible sheets are raised or lowered at least partially based on at least one of: a light level, a sound level, a temperature, a detection of nuclear particles, a time-of-day setting, a user input, a security system input, an insulation value setting, a sound threshold setting, a proximity detection, a wireless control signal, a voice activation signal, a voice recognition signal, a humidity signal, a vision system signal, a detected obstruction, or a sensed load.

17. The method of claim 16, wherein one or more of the flexible sheets are used as at least one of: a wall, a window, a door, a roof or a garage door.

18. The method of claim 16, wherein the time-of-day setting is dynamically determined based on a length of light of the light level within a 24-hour period.

19. The method of claim 11, wherein at least one of the one or more wireless control devices is a thermostat, a security system, a network, or a personal user device.

20. The method of claim 11, wherein at least one of the one or more wireless control devices is a battery-less transmitter.
